(19) United States
(12) Patent Application Publication
(10) Pub. No.: US 2023/0179062 A1
(43) Pub. Date: Jun. 8, 2023

(54) Drive Unit

(71) Applicant: ZF Friedrichshafen AG, Friedrichshafen (DE)

(72) Inventors: Steffen KRAFT, Blaustein (DE); Miran PERCIC, Heubach (DE); Rüdiger NIERESCHER, Schwäbisch Gmünd (DE); Klaus KRAFT, Blaustein (DE)

(21) Appl. No.: 17/913,621

(22) PCT Filed: Feb. 22, 2021
(86) PCT No.: PCT/EP2021/054260

§ 371 Date: Sep. 22, 2022

(30) Foreign Application Priority Data
Mar. 23, 2020 (DE) 10 2020 203 711.6

(51) Int. Cl. H02K 7/108; B62M 6/40; H02K 5/173; H02K 7/00; H02K 7/08; H02K 11/24; H02K 13/00

(52) U.S. Cl. CPC H02K 7/108; B62M 6/40; H02K 5/1732; H02K 7/003; H02K 7/083; H02K 11/24; H02K 13/003

(57) ABSTRACT

A drive unit (10) for a manually driven vehicle, in particular a bicycle or an EPAC, includes a housing (12), a bottom bracket shaft (14), an electric auxiliary drive (16), and an output shaft (22) designed as a hollow shaft. The bottom bracket shaft (14) and the output shaft (22) are coaxial. The output shaft (22) surrounds the bottom bracket shaft (14) at least partially along an axial direction. A first freewheel clutch (24) and a second freewheel clutch (26) are arranged radially between the bottom bracket shaft (14) and the output shaft (22). The freewheel clutches are axially adjacent and act on the output shaft (22).

### CROSS-REFERENCE TO RELATED APPLICATIONS

The present application is related and claims priority to 102020203711.6 filed in the German Patent Office on Mar. 23, 2020 and is a U.S. national phase of PCT/EP2021/054260 filed in the European Patent Office on Feb. 22, 2021, both of which are incorporated by reference in their entirety for all purposes.

### FIELD OF THE INVENTION

The invention relates generally to a drive unit for a manually driven vehicle, wherein a manually driven vehicle is in particular a vehicle operated by muscular force.

### BACKGROUND

DE 10 2015 100 676 A1 discloses a drive assembly with a manual drive, an electric auxiliary drive, and a common driven element. The drive unit has a complex structure with a large number of individual components and bearing points.

EP 2 724 926 A1 discloses a central drive unit with a bottom bracket shaft for manual drive and an auxiliary drive with a downstream planetary transmission. This drive unit also has a relatively complex structure with a large number of individual components.

DE 10 2014 108 611 A1 discloses a bicycle drive device with a drive housing for receiving a bottom bracket shaft and a harmonic drive which is arranged inside the drive housing and can be connected in driving fashion to a traction means carrier. This bicycle drive device also has a complex structure.

### SUMMARY OF THE INVENTION

Example aspects of the invention provide an improved drive unit. In particular, package optimization and a compact structure are desirable.

The drive unit is configured for a manually driven vehicle, in particular a bicycle or an EPAC (Electrically Power Assisted Cycle). The drive unit has a housing, a bottom bracket shaft, an electric auxiliary drive, and an output shaft designed as an essentially cup-shaped hollow shaft. The bottom bracket shaft and the output shaft are arranged coaxially with each other, and the output shaft surrounds the bottom bracket shaft axially in some regions and radially on the outside. A first freewheel clutch and a second freewheel clutch, which are adjacent to each other axially and act on the output shaft, are arranged radially between the bottom bracket shaft and the output shaft.

Good use of the available structural space can be achieved by the coaxial arrangement of the components, which favors a compact structure. The assemblies of the drive unit can thus be arranged centrally about the bottom bracket shaft, for example an electronic unit or an electronic circuit board, an electric motor, a gear unit, an output shaft, and/or freewheel clutches.

The freewheel clutches act on the output shaft and are thus in each case coupled mechanically to the output shaft on the output side, i.e., via an output of the freewheel clutch, for example an outer ring. The freewheel clutches can be coupled to an inner circumferential surface of the output shaft. This inner circumferential surface can be designed to be axially continuous, in particular with a constant diameter. Independently thereof, a chain ring or a chain ring carrier for coupling to a drive chain can be fastened to the output shaft.

The output of the freewheel clutches, for example the outer ring of the freewheel clutches, can be connected non-rotatably to the inner circumferential surface of the output shaft, for example by pressing in the freewheel clutch. The freewheel clutches can each have an inner ring, an outer ring, and control elements situated between them which enable a torque to be transmitted between the inner ring and outer ring in just one direction of rotation. The control elements can, for example, be clamping rollers, clamping bodies, ratchets, or the like.

The electric auxiliary drive can have an electric motor and a transmission unit, for example a harmonic drive, mechanically coupled thereto. The harmonic drive can have a wave generator, a deformable cylindrical socket with external teeth (flex spine), and a cylindrical outer bushing with internal teeth. The wave generator can be designed as an elliptical disk with rolling bearings arranged thereon and, optionally, a deformable raceway. The flex spline can be designed in the shape of a ring or a cup. The flex spine usually serves as an output of the harmonic drive.

The electric motor can be designed as an external rotor motor, i.e., the rotor of the electric motor can be designed as an external rotor. The rotor surrounds the stator radially on the outside. An advantageous power density and a compact size can be achieved as a result.

A stator carrier, which has an in particular sleeve-shaped carrying section and an in particular disk-shaped fastening section, can be provided. The stator can be fastened and/or the rotor mounted on the stator carrier, in particular on the carrying section, by a rolling bearing. Independently thereof, electronics, for example an electronic circuit board, can be fastened on the stator carrier, in particular on the fastening section. The stator carrier can be fastened inside the housing of the drive unit via the fastening section.

The first freewheel clutch can advantageously couple the bottom bracket shaft to the output shaft. Manual driving of the output shaft is thus possible, for example, by actuating the bottom bracket shaft by muscular force. Coupling of the flow of force takes place when a torque can be transmitted by one component, for example the bottom bracket shaft, to the other component, for example the output shaft.

The second freewheel clutch can expediently couple the force of flow between the electric auxiliary drive and the output shaft. An electric drive or auxiliary drive of the output shaft is thus possible. Coupling of the flow of force takes place when a torque can be transmitted by one component, for example the auxiliary drive, to the other component, for example the output shaft.

The electric auxiliary drive can advantageously have a harmonic drive with a flex spine, wherein the flex spine is coupled to the second freewheel clutch via a preferably annular adapter. An intermediate space between the flex spine and the second freewheel clutch can be bridged radially by the adapter. The output shaft can thus be configured more simply in structural and manufacturing terms. The adapter can optionally be hardened. This increases the stability of the adapter. As described above, the electric auxiliary drive can have an electric motor which is coupled to the harmonic drive. A torque of the electric motor can thus be transmitted to the output shaft by the harmonic drive and the adapter.

The flex spine, as an output of the harmonic drive, can expediently have a preferably sleeve-shaped coupling section via which the flex spine and the annular adapter are connected to each other in a connecting region, wherein a fit and/or an adhesive bond are formed in the connecting region. This contributes to precise and stable coupling of the flex spine and the adapter. A fit between the flex spine and the annular adapter can thus be formed in one part of the connecting region (fit region). An adhesive bond can be formed in a further part of the connecting region (adhesive bond region). The fit region and the adhesive bond region can in each case be separated from each other by a radial shoulder formed, for example, on the adapter and/or on the coupling section. The functional surfaces of the fit region and the adhesive bond region are thus separated from each other.

The bottom bracket shaft can advantageously have a first shaft part and a separate second shaft part or be formed from the first and second shaft parts, wherein the shaft parts can be connected to each other in particular reversibly and axially. The bottom bracket shaft can thus be divided, for example axially. Mounting is facilitated because an assembly can also be mounted simply inside the cylindrical housing of the drive unit. In the connecting region, a shaft part can have an axially projecting collar which surrounds the other shaft part radially on the outside in the connected state, i.e., the shaft parts overlap each other in the connecting region and one shaft part can have a plug-in section and the other shaft part a socket section corresponding thereto.

The two shaft parts can expediently be fastened to each other by a preferably centrally arranged screw connection. A structurally simple and stable fastening is possible hereby. The screw connection can be effected by just one screw. The central longitudinal axis of the screw can be aligned axially, i.e., oriented parallel or in particular coaxially with respect to the central longitudinal axis of the bottom bracket shaft. The screw can be pushed through a through hole in one shaft part, for example the second shaft part, and be screwed into a bore, provided with an internal thread, of the other shaft part, for example the first shaft part.

The bottom bracket shaft can advantageously be mounted rotatably at one end on a housing cover delimiting the housing at the front by a first bearing and/or the bottom bracket shaft can be mounted at the other end on the output shaft by a second bearing. Reliable and structurally favorable mounting of the bottom bracket shaft is produced hereby.

The bottom bracket shaft can expediently have a radially outward projecting shaft shoulder via which the bottom bracket shaft is coupled to the first freewheel clutch, wherein a sensor system for torque detection can be provided, which detects the torque at the shaft shoulder which is applied to the bottom bracket shaft, for example at the front. This represents a structurally favorable and at the same time space-saving structure because, whatever the measuring method used, it is possible to dispense with classical torque measurement by a sleeve.

The sensor system for torque detection can be attached to the bottom bracket shaft, for example to a front side of the shaft shoulder, and be fastened thereon. The sensor system can thus be applied at the measuring point and co-rotates with the shaft. Energy can be supplied from an electronic unit, for example an electronic circuit board, by sliding contacts or inductively. A signal from the sensor system can be transmitted to the electronic unit, for example the electronic circuit board, via radio or a sliding contact.

The sensor system for torque detection can expediently have one or more strain gauges which are attached to the shaft shoulder, for example at the front. Reliable detection of the torque is possible hereby. Torque determination, i.e., determining the torque applied to the bottom bracket shaft, can be effected with the aid of the detected deformation of the shaft shoulder relative to the bottom bracket shaft.

Alternatively or supplementarily, the sensor system for torque determination can advantageously have one or more magnetostrictive measuring elements, which are attached to the shaft shoulder, for example at the front. The torque can also be determined hereby. Torque determination, i.e., determining the torque applied to the bottom bracket shaft, can be effected with the aid of the detected shear stress of the shaft shoulder.

A sleeve which is pushed or pressed onto the bottom bracket shaft can expediently be provided, wherein the sleeve has a socket section for one or more rolling bearings of the flex spine, wherein the rolling bearing or bearings can be fixed axially in the socket section. Axial positioning of the bearing of the flex spine is thus possible in a structurally simple fashion. The rolling bearing or bearings is or are rolling bearings of the flex spine, which are arranged on the output side and are arranged, for example, on the coupling section of the flex spine. A perforation, extending for example axially, for the passage of electrical lines can be formed on the socket section. Electronics of the drive unit can thus be connected simply to the sensor system, i.e., electronics that are part of the sensor system.

A sealing surface for a sealing point between the bottom bracket shaft and a stator carrier, through which the bottom bracket shaft is guided, can advantageously be formed by the sleeve. A reliable separation can be formed at the stator carrier as a result. An electronic unit, for example an electronic circuit board, arranged on one side of the stator carrier can thus be separated from mechanical components, which may be provided with lubricant, arranged on the other side of the stator carrier. This reduces the risk of damage to the electronics.

The sleeve and the bottom bracket shaft can expediently be sealed by a sealing element, for example an O-ring, arranged radially between the bottom bracket shaft and the sleeve. Capillary effects radially between the bottom bracket shaft and the sleeve can be prevented as a result. This again reduces the risk of damage to the electronics.

A line guide, for example a duct, in which can be arranged electrical lines for power transmission and/or signal transmission between a sensor system for torque measurement, which is arranged for example on the shaft shoulder, and an electronic unit, for example an electronic circuit board arranged on the stator carrier, can advantageously be formed on or in the sleeve. As a result, electrical energy and/or signals can be transmitted through the sleeve in a particularly space-saving fashion.

One or more slip rings for electrical power transmission and/or signal transmission between the electronic unit and a sensor system for torque measurement can expediently be attached to the sleeve, preferably wherein the electronics, for example the electronic circuit board, can have one or more sliding contacts which each interact with a slip ring. Space-saving and easy-to-install power transmission and/or signal transmission is hereby possible. The signal from the sensor system can be modulated onto one of the slip rings, for example via a radio frequency.

### BRIEF DESCRIPTION OF THE DRAWINGS

Example aspects of the invention are explained in detail below with the aid of the drawings, wherein the same elements or those with the same function are provided with identical reference numerals. In the drawings:

FIG. 1 shows an exemplary embodiment of the drive unit in a view in section;

FIG. 2 shows the output shaft and the freewheel clutches of the drive unit from FIG. 1 in an enlarged partial view;

FIG. 3 shows the flex spline of the harmonic drive of the drive unit from FIG. 1 in an enlarged partial view;

FIG. 4 shows the bottom bracket shaft of the drive unit from FIG. 1 in a view in section;

FIG. 5 shows the bottom bracket shaft of the drive unit from FIG. 1 in a perspective view; and

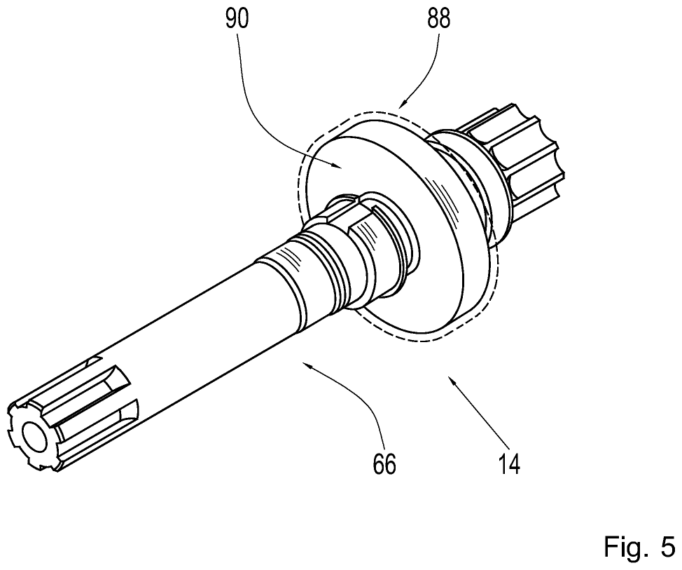

FIGS. 6a,b show the bottom bracket shaft, the sleeve, and the stator carrier of the drive unit from FIG. 1 in a front view (FIG. 6a) and a view in section (FIG. 6b).

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

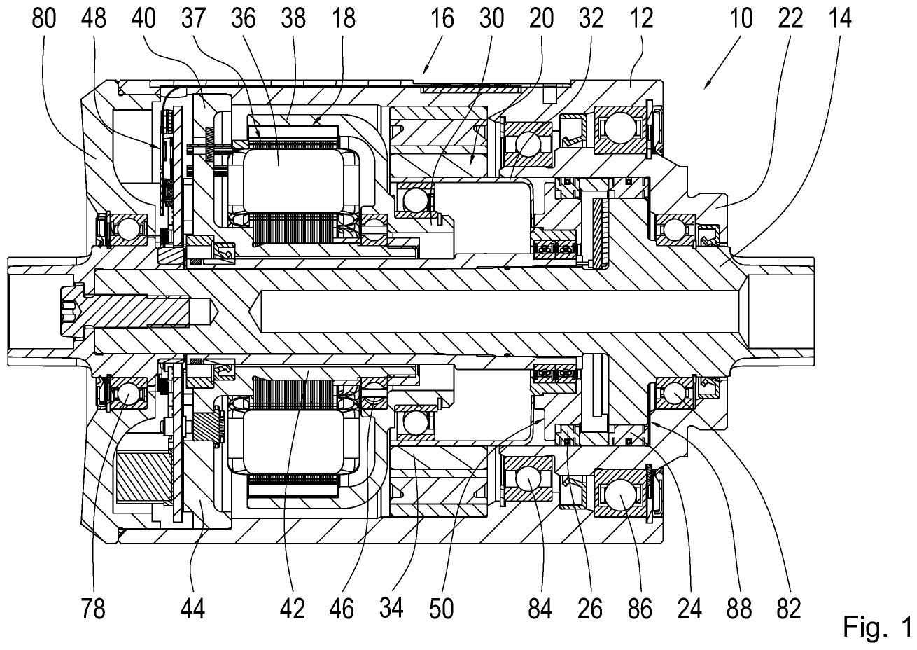

FIG. 1 shows a drive unit for a manually driven vehicle such as, for example, a bicycle or an EPAC, wherein the drive unit as a whole is designated by the reference numeral 10.

The drive unit 10 has a housing 12 on or in which the components of the drive unit 10 are arranged. The drive unit 10 has, for a manual drive by muscular force, a bottom bracket shaft 14 which is rotatably mounted in the housing 12 of the drive unit 10. In addition, the drive unit 10 has an electric auxiliary drive 16, which has an electric motor 18 and a harmonic drive 20. The drive unit 10 furthermore has an essentially cup-shaped output shaft 22 which is designed as a hollow shaft.

The bottom bracket shaft 14 and the output shaft 22 are arranged coaxially with each other and the output shaft 22 surrounds the bottom bracket shaft 14 axially in some regions and radially on the outside. A first freewheel clutch 24 and a second freewheel clutch 26, which are axially adjacent to each other and act on the output shaft 22, are arranged radially between the bottom bracket shaft 14 and the output shaft 22.

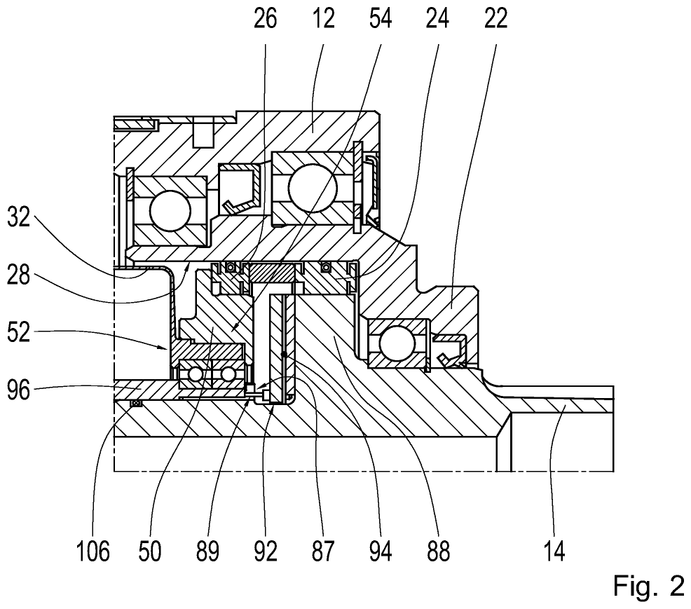

The freewheel clutches 24, 26 (FIG. 2) act mechanically on the output shaft 22 and are thus in each case coupled to the output shaft 22 on the output side, i.e., via an output of the freewheel clutches 24, 26, for example an outer ring. The freewheel clutches 24, 26 can, as in the illustrated example embodiment, be coupled to an inner circumferential surface 28 of the output shaft 22. The inner circumferential surface 28 can be designed to be axially continuous, in particular with a constant diameter. A chain ring or a chain ring carrier for coupling to a drive chain can be fastened (not illustrated) to the output shaft 22. The output of the freewheel clutches 24, 26, for example the outer rings of the freewheel clutches 24, 26, can be connected non-rotatably to the inner circumferential surface 28 of the output shaft 22, for example by pressing in the respective freewheel clutch.

The auxiliary drive 16 has an electric motor 18 and a coupled harmonic drive 20 (FIG. 1). The harmonic drive 20 has a wave generator 30, a deformable cylindrical inner bushing 32 with external teeth (flex spine) and a cylindrical outer bushing 34 with internal teeth.

The electric motor 18 has a stator 36 with stator windings 37 and a rotor 38. The electric motor 18 is designed in the illustrated example embodiment as an external rotor motor, i.e., the rotor 38 of the electric motor 18 is designed as an external rotor, and the rotor 38 surrounds the stator 36 radially on the outside.

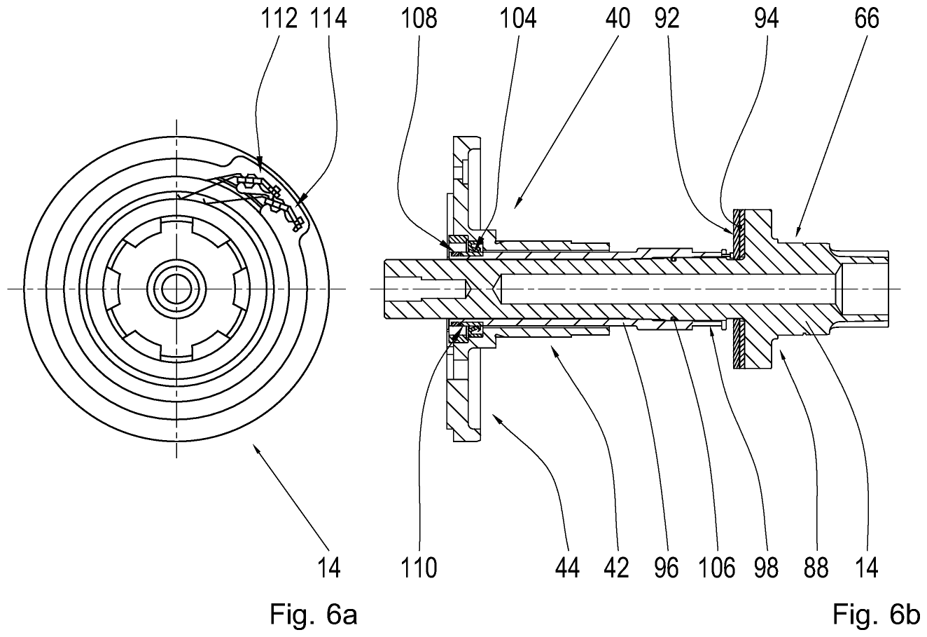

A stator carrier 40, which has an in particular sleeve-shaped carrying section 42 and a disk-shaped fastening section 44, is provided (FIG. 1, FIG. 6b). The stator 36 can, as in the illustrated example embodiment, be fastened and/or the rotor 38 mounted by a rolling bearing 46 on the stator carrier 40, in particular on the carrying section 42. Independently thereof, an electronic unit 48, for example an electronic circuit board, can be fastened on the stator carrier 40, in particular on the fastening section 44. The stator carrier 40 can be fastened in the housing 12 via the fastening section 44.

The first freewheel clutch 24 couples the bottom bracket shaft 14 to the output shaft 22. As a result, a torque can be transmitted to the output shaft 22 by the bottom bracket shaft 14 in a direction of rotation. The second freewheel clutch 26 couples the electric auxiliary drive 16 to the output shaft 22. As a result, a torque can be transmitted to the output shaft 22 by the auxiliary drive 16 in a direction of rotation.

As already explained, the electric auxiliary drive 16 has a harmonic drive 20 with a flex spine 32, wherein the flex spine 32 is coupled to the second freewheel clutch 26 via a preferably annular adapter 50. The adapter 50 can optionally be hardened.

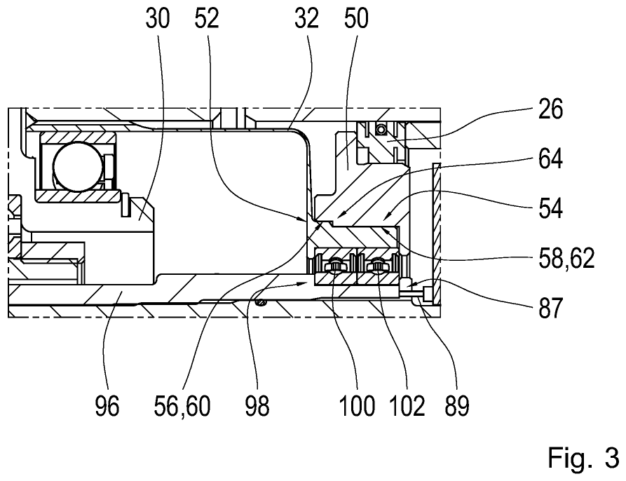

The flex spine 52 has a preferably sleeve-shaped coupling section 52 via which the flex spine 32 and the adapter 50 are connected to each other in a connecting region 54 (FIGS. 2 and 3), wherein an interference fit 56 and/or an adhesive bond 58 are formed in the connecting region. A fit 56 between the flex spine 32 and the adapter 50 is formed in one part 60 of the connecting region 54 (fit region 60). An adhesive bond 58 is formed in a further part 62 of the connecting region 54 (adhesive bond region 62). The fit region 60 and the adhesive bond region 62 can, as in the illustrated example embodiment, in each case be separated from each other by a radial shoulder 64 formed on the adapter 50 and on the coupling section 52.

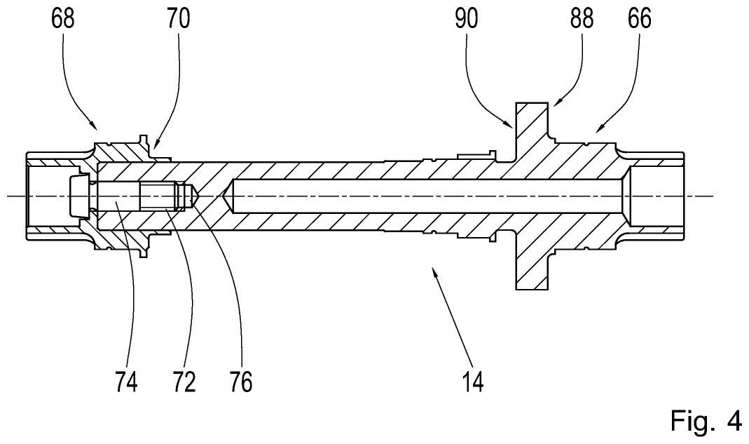

The bottom bracket shaft 14 has a first shaft part 66 and a separate second shaft part 68 (FIG. 4) and is formed from the first and second shaft parts 66, 68, wherein the shaft parts 66, 68 can be connected to each other in particular reversibly or removably. The bottom bracket shaft 14 can thus be divided axially. In the connecting region, the second shaft part 68 has an axially projecting collar 70 which surrounds the first shaft part 66 radially on the outside in the connected state. Thus, the shaft parts 66, 68 overlap each other in the connecting region in the connected state.

The two shaft parts 66, 68 can be fastened to each other by a preferably centrally arranged screw connection 72. The screw connection 72 can be effected by just one screw 74. The central longitudinal axis of the screw 74 is aligned axially, i.e., oriented parallel or in particular coaxially with respect to the central longitudinal axis of the bottom bracket shaft 14. The screw 74 can be pushed through a through hole in the second shaft part 68 and be screwed into a bore 76, provided with an internal thread, of the first shaft part 66.

The bottom bracket shaft 14 is mounted rotatably at one end on a housing cover 80 delimiting the housing 12 at the front by a first bearing 78 (FIG. 1). In addition, the bottom bracket shaft 14 is mounted rotatably at the other end on the output shaft 22 by a second bearing 82. The output shaft 22 is in turn mounted rotatably on the output shaft 22 with a third bearing 84 and a fourth bearing 86.

The bottom bracket shaft 14 has a radially outward projecting shaft shoulder 88 (FIGS. 1 and 2) via which the bottom bracket shaft 14 is coupled to the first freewheel clutch 24. A sensor system 92 for torque detection is provided (FIGS. 2 and 6b), which detects the torque at the shaft shoulder 88 that is applied to the bottom bracket shaft 14, in particular at the front, i.e., at the front side 90 of the shaft shoulder 88.

The sensor system 92 for torque detection can be attached to the bottom bracket shaft 14, for example to the front side 90 of the shaft shoulder 88, and be fastened thereon. The sensor system 92 can thus be applied at the measuring point, i.e., the front side 90 of the shaft shoulder 88, and co-rotates with the bottom bracket shaft 14.

The sensor system 92 for torque detection can have one or more strain gauges (not illustrated) which are attached to the shaft shoulder 88 at the front. Torque determination can be effected with the aid of the detected deformation of the shaft shoulder 88 relative to the bottom bracket shaft 14.

Alternatively or supplementarily, the sensor system 92 for torque determination can have one or more magnetostrictive measuring elements 94 which are attached at the front, i.e., to the front side 90 of the shaft shoulder 88. Torque determination can be effected with the aid of the detected shear stress of the shaft shoulder 88.

The drive unit 10 has a sleeve 96 which is pushed or pressed onto the bottom bracket shaft 14 (FIGS. 3 and 6b), wherein the sleeve 96 has a socket section 98 for one or more rolling bearings 100, 102 of the flex spine 32, wherein the rolling bearing or bearings 100, 102 can be fixed axially in the socket section 98. Axial positioning of the bearing of the flex spine is thus possible in a structurally simple fashion. The rolling bearings 100, 102 mount the flex spine 32 on the coupling section 52. A perforation 87, extending axially, for the passage of electrical lines 89 is formed on the socket section 98. The lines 89 connect the electronics 48 of the drive unit 10 to electronics (not illustrated) which are part of the sensor system 92.

A sealing surface 104 for a sealing point between the bottom bracket shaft 14 and the stator carrier 40, through which the bottom bracket shaft 14 is guided, is formed by the sleeve 96.

The sleeve 96 and the bottom bracket shaft 14 are sealed by a sealing element 106, for example an O-ring 106, arranged radially between the bottom bracket shaft 14 and the sleeve 96.

A line guide, for example a duct, in which can be arranged electrical lines 89 for power transmission and/or signal transmission between the sensor system 92 for torque detection and the electronic unit 48, can advantageously be formed (not illustrated) on or in the sleeve 96.

One or more slip rings 108, 110 (FIGS. 6a,b) for power transmission and/or signal transmission between the electronic unit 48, in particular the electronic circuit board, and the sensor system 92 for torque measurement are attached to the sleeve 96. The electronic unit 48, for example the electronic circuit board, has one or more electrical sliding contacts 112, 114 which each interact with a slip ring 108, 110.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### LIST OF REFERENCE NUMERALS

10 drive unit
12 housing
14 bottom bracket shaft
16 auxiliary drive, electric
18 electric motor
20 harmonic drive
22 output shaft
24 first freewheel clutch
26 second freewheel clutch
28 inner circumferential surface
30 wave generator
32 deformable inner bushing, flex spine
34 outer bushing
36 stator
37 stator windings
38 rotor
40 stator carrier
42 carrying section
44 fastening section
46 rolling bearing
48 electronic unit, circuit board
50 adapter
52 coupling section
54 connecting region
56 fit
58 adhesive bond
60 fit region
62 adhesive bond region
64 radial shoulder
66 first shaft part
68 second shaft part
70 projecting collar
72 screw connection
74 screw
76 bore
78 first bearing
80 housing cover
82 second bearing
84 third bearing
86 fourth bearing
87 perforation
88 shaft shoulder
89 electrical lines
90 front side
92 sensor system
94 magnetostrictive measuring elements
96 sleeve
98 socket section
100 rolling bearing
102 rolling bearing
104 sealing surface
106 sealing element
108 slip ring
110 slip ring
112 sliding contact
114 sliding contact

1-12. (canceled)

13. A drive unit (10) for a manually driven vehicle, namely a bicycle or an EPAC, comprising:
a housing (12);
a bottom bracket shaft (14);
an electric auxiliary drive (16);
an output shaft (22) designed as a hollow shaft, the output shaft (22) arranged coaxially with the bottom bracket shaft (14), the output shaft (22) partially surrounding the bottom bracket shaft (14) along an axial direction; and
a first freewheel clutch (24) adjacent to a second freewheel clutch (26) along the axial direction, the first and second freewheel clutches (24, 26) acting on the output shaft (22) and arranged radially between the bottom bracket shaft (14) and the output shaft (22).

14. The drive unit (10) of claim 13, wherein the first freewheel clutch (24) couples the bottom bracket shaft (14) to the output shaft (22), and the second freewheel clutch (26) couples the electric auxiliary drive (16) to the output shaft (22).

15. The drive unit (10) of claim 13, wherein the electric auxiliary drive (16) comprises a harmonic drive (20) with a flex spine (32), and the flex spine (32) is coupled to the second freewheel clutch (26) via an adapter (50).

16. The drive unit (10) of claim 15, wherein the adapter (50) is annular.

17. The drive unit (10) of claim 15, wherein the flex spine (32) comprises a coupling section (52) via which the flex spine (32) is connected to the adapter (50) in a connecting region (54), and one or both of an interference fit (56) and an adhesive bond (58) are formed in the connecting region (54).

18. The drive unit (10) of claim 13, wherein the bottom bracket shaft (14) comprises a first shaft part (66) connectable to a separate second shaft part (68).

19. The drive unit (10) of claim 18, wherein the first shaft part (66) is fastened to the second shaft part (68) by a screw connection (72).

20. The drive unit (10) of claim 19, wherein the screw connection (72) is centrally arranged with the first and second shaft parts (66, 68).

21. The drive unit (10) of claim 13, wherein the bottom bracket shaft (14) is mounted rotatably on a housing cover (80) delimiting the housing (12) by a first bearing (78), and the bottom bracket shaft (14) is mounted on the output shaft (22) by a second bearing (82).

22. The drive unit (10) of claim 13, further comprising a sensor system (92), wherein the bottom bracket shaft (14) comprises a radially outward projecting shaft shoulder (88) via which the bottom bracket shaft (14) is coupled to the first freewheel clutch (24), the sensor system (92) configured for detection of torque applied to the bottom bracket shaft (14) at the shaft shoulder (88).

23. The drive unit (10) of claim 22, wherein the sensor system (92) comprises one or more strain gauges or one or more magnetostrictive measuring elements (94).

24. The drive unit (10) of claim 13, further comprising a sleeve (96) pushed or pressed onto the bottom bracket shaft (14), wherein the sleeve (96) comprises a socket section (98) for axially fixing one or more rolling bearings (100, 102) of the flex spine (32).

25. The drive unit (10) of claim 24, wherein the sleeve (96) forms a sealing surface (104) for a sealing point between the bottom bracket shaft (14) and a stator carrier (40), the bottom bracket shaft (14) guided through the sealing surface (104).

26. The drive unit (10) of claim 24, wherein one or both of:
a line guide is formed on or in the sleeve (96), the line guide configured such that electrical lines (89) for power transmission and/or signal transmission between a sensor system for torque measurement and an electronic unit (48) are received in the line guide; and
one or more slip rings (108, 110) for the power transmission and/or the signal transmission between the electronic unit (48) and the sensor system for torque measurement are attached on the sleeve (96).
